(19) United States
(12) Patent Application Publication
(10) Pub. No.: US 2013/0312527 A1
(43) Pub. Date: Nov. 28, 2013

(54) INTEGRATED EXCITATION AND MEASUREMENT SYSTEM

(71) Applicant: Richard A. Lomenzo, JR., Enfield, CT (US)

(72) Inventor: Richard A. Lomenzo, JR., Enfield, CT (US)

(21) Appl. No.: 13/477,644

(22) Filed: May 22, 2012

(51) Int. Cl. G01N 29/00

(52) U.S. Cl. 73/632

(57) ABSTRACT

An integrated excitation and measurement system includes a support member. A single confocal ultrasonic transducer is mounted to the support member. The ultrasonic transducer is configured to produce first and second ultrasonic beams having different frequencies than one another that generate an excitation input at a focal point. First, second and third fiber optic elements are mounted to the support member and aligned with the focal point. The fiber optic elements are configured to sense a three-dimensional excitation response at the focal point.

### BACKGROUND

This disclosure relates to an excitation and measurement system for determining a vibratory response to an input. More particularly, the disclosure relates to an integrated non-contacting excitation and measurement system and method.

During the design of a product, it may be desirable to determine a vibratory response of an object resulting from an input used to excite the object. In one example, an object receives a mechanical input, such as being struck with a hammer. Accelerometers may be adhered to the object to measure the vibratory response from the input. This information may be used to design the product in such a way so as to avoid undesired resonant frequencies within the operating range of the product.

It may be desirable to use a non-contact excitation input rather mechanically contacting the object. It may also be desirable to measure the vibrational response without contact. To this end, systems have been designed to excite and measure vibrational input of an object using non-contacting means. However, the systems are rather large and complex, and only measure the vibrational response in one dimension.

### SUMMARY

In one exemplary embodiment, an integrated excitation and measurement system includes a support member. A single confocal ultrasonic transducer is mounted to the support member. The ultrasonic transducer is configured to produce first and second ultrasonic beams having different frequencies than one another that generate an excitation input at a focal point. First, second and third fiber optic elements are mounted to the support member and are aligned with the focal point. The fiber optic elements are configured to sense a three-dimensional excitation response at the focal point.

In a further embodiment of any of the above, the first, second and third fiber optic elements circumscribe the ultrasonic transducer.

In a further embodiment of any of the above, the fiber optic elements are arranged in three orthogonal directions.

In a further embodiment of any of the above, an adjustment member is provided on the support member and is configured to adjust the ultrasonic transducer and the fiber optic elements relative to one another.

In a further embodiment of any of the above, the adjustment members cooperate with the fiber optic elements.

In a further embodiment of any of the above, the system includes a support stand to which the support member is mounted.

In a further embodiment of any of the above, an adjustment assembly is configured to adjust the focal point relative to an object.

In a further embodiment of any of the above, the focal point is less than 6 inches (15.2 cm) from the ultrasonic transducer.

In a further embodiment of any of the above, the focal point is about 2 inches (5.1 cm) from the ultrasonic transducer.

In a further embodiment of any of the above, a signal generator is in communication with the ultrasonic transducer and is configured to provide the first and second ultrasonic beams. An amplifier is provided between the signal generator and the ultrasonic transducer.

In a further embodiment of any of the above, a data acquisition device is in communication with the signal generator and is configured to receive excitation information.

In a further embodiment of any of the above, first, second and third laser vibrometers are respectively in communication with the first, second and third fiber optic elements. The first, second and third laser vibrometers are in communication with the data acquisition device.

In a further embodiment of any of the above, a post-processing unit is in communication with the data acquisition device and is configured to receive the three-dimensional excitation response.

In one exemplary embodiment, a method of providing an excitation and three-dimensional measurement of an object includes the steps of ultrasonically exciting an object, and determining a three-dimensional vibrational response without contact and in response to the exciting step.

In a further embodiment of any of the above, the ultrasonically exciting step includes providing different frequencies converging at a common focal point with a single ultrasonic transducer.

In a further embodiment of any of the above, the determining step includes measuring the vibrational response with three laser vibrometers directing laser beams at the common focal point.

### BRIEF DESCRIPTION OF THE DRAWINGS

The disclosure can be further understood by reference to the following detailed description when considered in connection with the accompanying drawings wherein:

FIG. 1 is a schematic view of an integrated excitation and three-dimensional measurement system.

FIG. 2 depicts the orthogonal orientation of three fiber optic elements.

### DETAILED DESCRIPTION

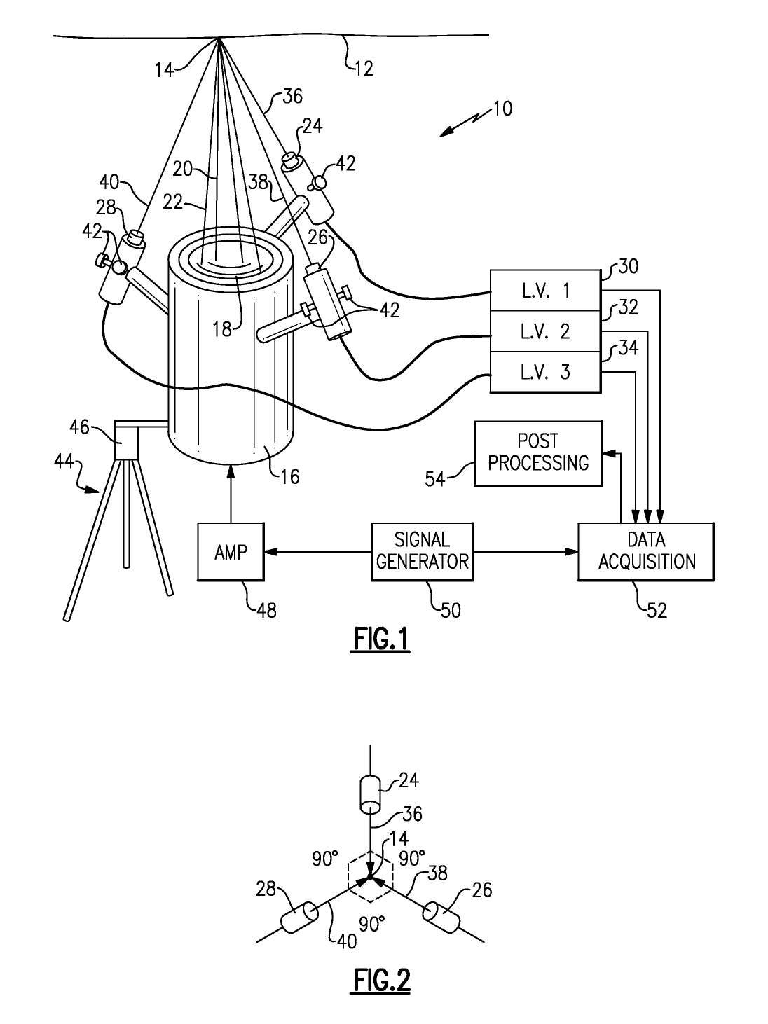

FIG. 1 schematically illustrates an example integrated excitation and three-dimensional measurement system 10. The system 10 includes an ultrasonic transducer 18 mounted to a support member 16. In one example, the support member 16 is rather compact, about 6 inches (15.2 cm) in diameter. In the example, the ultrasonic transducer 18 is a confocal transducer that produces two ultrasonic signals having a common focal point 14. One example dual-element confocal ultrasonic transducer is available from MicroAcoustic, available under the trade name BAT-5. The ultrasonic transducer 18 produces first and second ultrasonic signals 20, 22. The ultrasonic transducer 18 may be adjustable along the axis of the first and second ultrasonic signals 20, 22 to align the focal point of the ultrasonic transducer 18, relative to the laser beams discussed below.

In use, the focal point 14 is configured to be provided on the surface of an object 12. The focal point 14 is less than 6 inches (15.2 cm) away from the ultrasonic transducer 18, and in one example, around 2 inches (5.1 cm) from the ultrasonic transducer 18.

First, second and third laser vibrometer fiber optic elements 24, 26, 28 are mounted to the support member 16 and circumscribe the ultrasonic transducer 18 120° apart from one another. In the example, the fiber optic elements 24, 26, 28 are arranged orthogonally relative to one another at 90° relative to one another, as shown in FIG. 2. The fiber optic elements 24, 26, 28 are aligned with and converge upon the focal point 14. Such an arrangement avoids additional calculations that would be needed to determine the x, y, z velocity components. Adjustment members 42 may be used to align the first, second and third laser beams 36, 38, 40 with the focal point 14. In the example, the adjustment members 42 are associated with the first, second and third fiber optic elements 24, 26, 28.

The first, second and third fiber optic elements 24, 26, 28 are connected to first, second and third laser vibrometers 30, 32, 34, which respectively generate first, second and third laser beams 36, 38, 40 that are directed at the focal point 14. One example laser vibrometer is available from Polytec.

The support member 16 is mounted to a support stand 44, such as a tripod. The support stand 44 may include an adjustment assembly 46 that is configured to position the support member 16, and in particular, the focal point 14 relative to the object 12 in a desired position. The support member 16 may also be handheld.

A signal generator 50 is in communication with the ultrasonic transducer 18 to produce first and second frequency signals that are different than one another and which provide the first and second ultrasonic signals 20, 22. The first and second frequency signals may pass through an amplifier 48. In one example, the first and second frequency signals are respectively 400 MHz and 410 MHz. Other frequencies may be used. The convergence of the different frequencies induces an interference that generates an excitation at the focal point 14, thus generating a vibrational input to the object 12 without contact.

The signal generator 50 communicates with a data acquisition device 52 to provide the excitation information. The first, second and third laser vibrometers 30, 32, 34 also communicate with the data acquisition device 52. A post-processing unit 54 receives information from the data acquisition device 52 to translate the information from the first, second and third laser vibrometers 30, 32, 34 to a three-dimensional coordinate system. The three-dimensional coordinate information is processed to determine the velocity components and the vibrational response of the object 12 resulting from the excitation input. The information from the post-processing unit may be provided to an output device, such as a display device or storage medium.

It should be noted that a computing device can be used to implement various functionality disclosed in this application. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

Although an example embodiment has been disclosed, a worker of ordinary skill in this art would recognize that certain modifications would come within the scope of the claims. For that reason, the following claims should be studied to determine their true scope and content.

What is claimed is:

1. An integrated excitation and measurement system comprising:
a support member;
a single confocal ultrasonic transducer mounted to the support member, the ultrasonic transducer configured to produce first and second ultrasonic beams having different frequencies than one another that generate an excitation input at a focal point; and
first, second and third fiber optic elements mounted to the support member and aligned with the focal point, the fiber optic elements configured to sense a three-dimensional excitation response at the focal point.

2. The system according to claim 1, wherein the first, second and third fiber optic elements circumscribe the ultrasonic transducer.

3. The system according to claim 2, wherein the fiber optic elements are arranged in three orthogonal directions.

4. The system according to claim 1, comprising an adjustment member provided on the support member and configured to adjust the ultrasonic transducer and the fiber optic elements relative to one another.

5. The system according to claim 4, wherein the adjustment members cooperate with the fiber optic elements.

6. The system according to claim 1, comprising a support stand to which the support member is mounted.

7. The system according to claim 6, comprising an adjustment assembly configured to adjust the focal point relative to an object.

8. The system according to claim 7, wherein the focal point is less than 6 inches (15.2 cm) from the ultrasonic transducer.

9. The system according to claim 8, wherein the focal point is about 2 inches (5.1 cm) from the ultrasonic transducer.

10. The system according to claim 1, comprising a signal generator in communication with the ultrasonic transducer and configured to provide the first and second ultrasonic beams, and an amplifier provided between the signal generator and the ultrasonic transducer.

11. The system according to claim 10, comprising a data acquisition device in communication with the signal generator and configured to receive excitation information.

12. The system according to claim 11, comprising first, second and third laser vibrometers respectively in communication with the first, second and third fiber optic elements, the first, second and third laser vibrometers in communication with the data acquisition device.

13. The system according to claim 12, comprising a post-processing unit in communication with the data acquisition device and configured to receive the three-dimensional excitation response.

14. A method of providing an excitation and three-dimensional measurement of an object, comprising the steps of:
ultrasonically exciting an object; and
determining a three-dimensional vibrational response without contact and in response to the exciting step.

15. The method according to claim 14, wherein the ultrasonically exciting step includes providing different frequencies converging at a common focal point with a single ultrasonic transducer.

16. The method according to claim 15, wherein the determining step includes measuring the vibrational response with three laser vibrometers directing laser beams at the common focal point.
